(19) United States
(12) Patent Application Publication
(10) Pub. No.: US 2015/0195893 A1
(43) Pub. Date: Jul. 9, 2015

(54) BALLAST FOR GAS DISCHARGE LAMPS

(71) Applicant: General Electric Company, Schenectady, NY (US)

(72) Inventor: Zhijun Luo, ShangHai (CN)

(21) Appl. No.: 14/413,897

(22) PCT Filed: Jun. 10, 2013
(86) PCT No.: PCT/US2013/044917

§ 371 Date: Jan. 9, 2015

(30) Foreign Application Priority Data
Jul. 31, 2012 (CN) 201210267884.8

(51) Int. Cl. H05B 41/288

(52) U.S. Cl. CPC H05B 41/288

(57) ABSTRACT

A multi-stage ballast for powering a gas discharge lamp includes a power factor correction stage configured to receive an AC input power and produce a phase corrected DC power, a buck regulator stage coupled to the phase corrected DC power and configured to produce a regulated DC power. The buck regulator stage includes a buck switch. The ballast also includes a DC to AC inverter stage coupled to the regulated DC power and configured to produce an AC lamp power, and a microcontroller coupled to the inverter stage and to the buck switch. The microcontroller is configured to determine when the inverter enters transition and to shut off the buck switch for a predetermined period of time after the inverter enters transition.

### BACKGROUND

The aspects of the present disclosure relate generally to gas discharge lamps and in particular to improved electronic ballasts for powering gas discharge lamps.

Gas discharge lamps belonging to a family of lighting devices, such as fluorescent lamps used in residential and industrial lighting and high intensity discharge lamps used in stadium lighting and automobile headlamps, have specialized power requirements. When starting or igniting a gas discharge lamp, a high voltage is used to ionize gases contained in the lamp tube and initiate an arc within the lamp. Once an arc has been established and the lamp has warmed to its desired operating temperature, the lamp enters a normal operating phase where it exhibits a negative resistance characteristic. Negative resistance is a condition where lamp current varies inversely with applied voltage and can create an unstable condition leading to excessive lamp current which may deteriorate or destroy the lamp. Thus, it is necessary to carefully control the lamp current to avoid damaging the lamp. When a lamp fails it is necessary to shut off power to the lamp to prevent overheating and possible fracturing of the lamp tube which could release the harmful chemicals contained in the lamp. It is also desirable to shut down the lamp current when a lamp is removed to avoid a shock hazard for maintenance workers who replace failed lamps.

A ballast is an electrical apparatus used to provide power to a load, such as a gas discharge lamp, and to regulate its current. When driving gas discharge lamps, the ballast is configured to provide a high voltage to ignite the lamp, regulate the current at safe operating levels during normal operation, and to shut down lamp power when a lamp fails or is removed. If the ignition voltage is applied for too long, the lamp may be overstressed or otherwise damaged. Under certain conditions, application of the ignition voltage may fail to ignite the lamp within a safe period of time. When this occurs, the ignition voltage must be removed to allow the lamp to cool before another ignition attempt is made. The process of applying an ignition voltage, checking for ignition, then waiting for a cooling period is referred to as an ignition cycle. The ballast is typically configured to apply several ignition cycles to the lamp in order to achieve reliable lamp starting under a wide range of environmental conditions and to enter a failure mode where lamp power is shut down if the lamp fails to start after predefined number of ignition cycles has been attempted.

Typical modern lamp ballasts include multiple power conversion stages. While various combinations of stages may be used, a common set of stages includes an AC to DC conversion stage, a power factor correction (PFC) stage, a power regulator stage, and a DC to AC inverter stage. Alternating current (AC) grid power is rectified and filtered to create rectified direct current (DC) power by the AC to DC conversion stage. The rectified power is passed through the PFC stage to keep the current drawn from the power grid in phase with the voltage of the power grid thereby maintaining a near unity power factor for efficient power usage. The PFC stage may be followed by a power regulator, typically configured as a buck regulator, which receives power factor corrected DC power from the PFC stage and produces a regulated DC power to control a power delivered to the lamp. A DC to AC inverter converts the regulated DC power into an AC power to drive the load.

Each stage in the ballast typically uses an operating voltage, such as a common collector voltage, Vcc, to operate control and logic circuits internal to each stage. These operating voltages are often provided from a secondary winding magnetically coupled to an energy storage inductor in the PFC stage. When a lamp fails or is removed from the ballast and between ignition cycles, lamp power is shut down resulting in a low-load or no-load condition in the ballast. During these low-load or no-load conditions there is insufficient current flowing through the PFC stage to provide sufficient Vcc power to operate control circuitry in each of the stages. To provide control voltage during periods of low-load or no-load, a linear power supply is typically included to maintain the control voltage. Linear supplies of this type dissipate significant amounts of power resulting in reduced ballast efficiency and the need for expensive and relatively large power components. Thus, there is a need for methods and apparatus to reduce power dissipations in lamp ballasts.

A typical AC to DC inverter stage as included in multi-stage ballasts, uses controllably conductive switching devices to chop a regulated DC power to produce an AC output power for the lamp. The inverter stage operates the switching device to alternately apply a forward current to the output power then apply a reverse current to the output power. The periods where current is changing direction, i.e. transitioning from forward current to reverse current and from reverse current to forward current, are referred to as transition periods, and when the inverter is reversing the direction of the current it is said to be in transition. Further, when an inverter begins reversing the current it is said to be entering transition. During these transition periods the power drawn by the load is significantly less than during normal operation and may be only about a third of the normal power. This reduced current requirement results in current spikes being transmitted to the lamp while the inverter is in transition for a ballast configured to have constant power output. When the ballast is driving an electrical discharge lamp, these current spikes can stress the lamp leading to reduced lamp performance and life.

Current crest factor (CCF) is a common measure of quality used to evaluate gas discharge lamp ballasts. The crest factor of a waveform is defined as the peak value divided by the root mean square (RMS) value. An ideal square wave has a crest value of one since its peak and RMS values are the same. Spikes of current, such as the spikes occurring during inverter transition, have large amplitude but contain little RMS power resulting in a high CCF value. A lamp ballast with a CCF close to unity will provide much better lamp life than a ballast with a large CCF, such as a CCF greater than about 2.

Accordingly, it would be desirable to provide ballast circuits that solve at least some of the problems identified above.

### SUMMARY

As described herein, the exemplary embodiments overcome one or more of the above or other disadvantages known in the art.

One aspect of the present disclosure relates to a multi-stage ballast for powering a gas discharge lamp. In one embodiment, the multi-stage ballast includes a power factor correction stage configured to receive an AC input power and produce a phase corrected DC power, a buck regulator stage coupled to the phase corrected DC power and configured to produce a regulated DC power. The buck regulator stage includes a buck switch. The ballast also includes a DC to AC inverter stage coupled to the regulated DC power and configured to produce an AC lamp power, and a microcontroller coupled to the inverter stage and to the buck switch. The microcontroller is configured to determine when the inverter enters transition and to shut off the buck switch for a predetermined period of time after the inverter enters transition.

Another aspect of the present disclosure relates to an electroluminescent device. In one embodiment, the electroluminescent device includes an AC to DC rectifier device configured to receive an AC input power and produce a rectified DC power, a power factor correction stage coupled to the rectified DC power and configured to produce a phase corrected DC power, and a buck regulator stage coupled to the phase corrected DC power and configured to produce a regulated DC power. The buck regulator stage includes a buck switch. The electroluminescent device also includes a DC to AC inverter stage coupled to the regulated DC power and configured to produce an AC lamp power, a microcontroller coupled to the inverter stage and to the buck switch, an internal power supply coupled to the rectified DC power and configured to produce a first operating voltage, and a gas discharge lamp coupled to the AC lamp power. The power factor correction stage, the buck regulator stage, and the inverter stage each include control circuitry coupled to the first operating voltage, and the microcontroller is configured to determine when the ballast is in a standby mode and to turn off the first operating voltage while the ballast is in standby mode.

These and other aspects and advantages of the exemplary embodiments will become apparent from the following detailed description considered in conjunction with the accompanying drawings. It is to be understood, however, that the drawings are designed solely for purposes of illustration and not as a definition of the limits of the invention, for which reference should be made to the appended claims. Additional aspects and advantages of the invention will be set forth in the description that follows, and in part will be obvious from the description, or may be learned by practice of the invention. Moreover, the aspects and advantages of the invention may be realized and obtained by means of the instrumentalities and combinations particularly pointed out in the appended claims.

### BRIEF DESCRIPTION OF THE DRAWINGS

In the drawings:

FIG. 1 illustrates a block diagram of a multi-stage ballast for powering a gas discharge lamp incorporating aspects of the present disclosure.

FIG. 2 illustrates a block diagram of an exemplary architecture for supplying operating voltages to control circuitry within a multi-stage ballast incorporating aspects of the present disclosure.

FIG. 3 illustrates a schematic diagram of an exemplary embodiment of a switching circuit incorporating aspects of the present disclosure.

FIG. 4 illustrates an embodiment of a buck regulator and an inverter incorporating aspects of the present disclosure.

FIG. 5 illustrates a graph showing current delivered to the load by a typical multi-stage ballast.

FIG. 6 illustrates a graph showing lamp current delivered to a load by a multi-stage ballast employing a CCF control method incorporating aspects of the present disclosure.

FIG. 7 illustrates an embodiment of a buck control circuit that may be used to implement a CCF control method in multi-stage ballasts incorporating aspects of the present disclosure.

### DETAILED DESCRIPTION OF THE DISCLOSED EMBODIMENTS

Reference will now be made in detail to the various embodiments, one or more examples of which are illustrated in the drawings. Each example is provided by way of explanation and is not meant as a limitation. For example, features illustrated or described as part of one embodiment can be used on or in conjunction with other embodiments to yield yet further embodiments. It is intended that the present disclosure includes such modifications and variations.

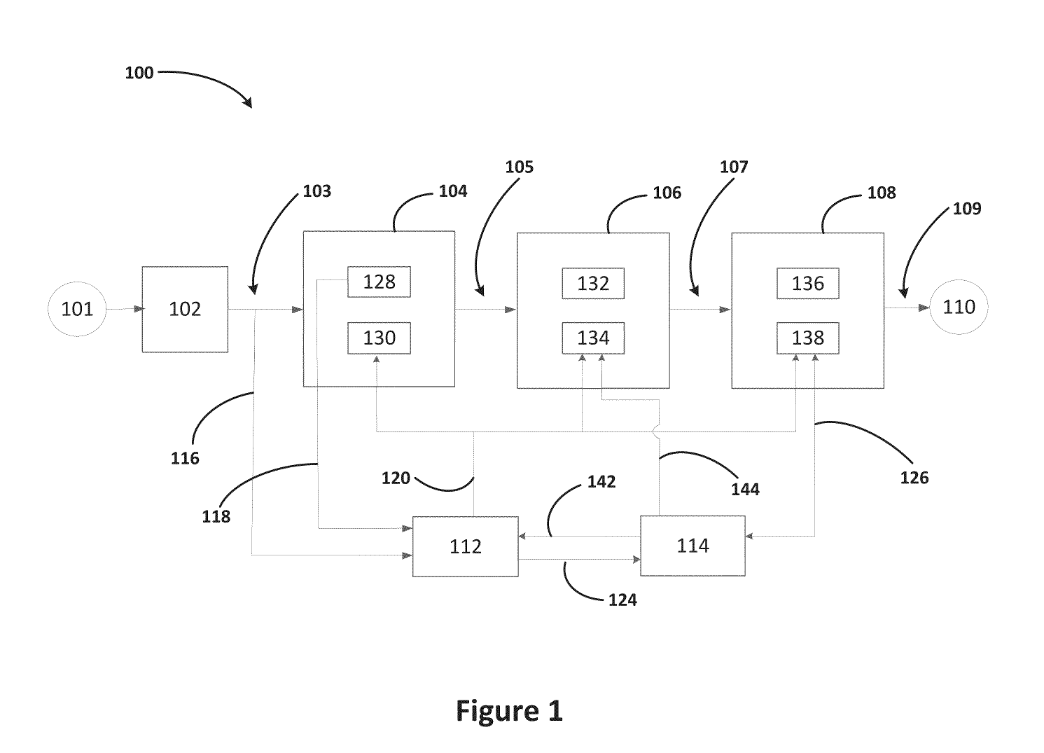

Referring now to FIG. 1 there can be seen a block diagram of a multi-stage ballast 100 that is appropriate for providing power and current regulation for loads 110 such as high intensity discharge (HID) lamps or other types of gas discharge lamps and electroluminescent devices. The ballast 100 is configured to receive input power 101 from a local mains power grid or other suitable AC power source such as the 120 volt, 60 Hertz power available in the United States, 50 Hertz 230 volt power available in many European countries, as well as other locally available grid power. A rectifier stage 102 converts the AC grid power 101 to rectified power 103 which is provided to a power factor correction (PFC) stage 104. The PFC stage 104 is configured to keep the current drawn from the grid power 101 in phase with the voltage of the grid power thus maintaining a power factor of the ballast at or near unity. The PFC stage 104 includes a switched mode power converter 128 typically configured as a boost topology with an inductive energy storage element (not shown) and a controllably conductive switching device (not shown). Control circuitry 130 configured to operate the switched mode power converter 128 in transition mode such that the current drawn from the input power 101 is in phase with the voltage of the input power 101. Control circuitry 130 includes various discrete components and integrated circuits, such as for example the transition mode PFC controller L6562D manufactured by STMICROELECTRONICS, to monitor signals within the PFC stage 104 and operate the switched mode power converter 128. An operating voltage 120 is provided to the control circuitry 130 by an operating voltage power supply 112 to provide operating power to its components and integrated circuits. The phase corrected power 105 produced by the PFC stage 104 is provided to a power regulator stage 106 that produces a regulated DC power 107. The power regulator is typically configured as a switched mode buck regulator 132 that includes a controllably conductive switching device, known as a buck switch. The buck switch is rapidly turned on and off by the buck control circuitry 134 to maintain a substantially constant level of power in the regulated DC power 107. Alternatively, the control circuitry 134 can be configured to maintain a substantially constant voltage or a substantially constant current in the regulated DC power 107. The buck control circuitry 134 may include both discrete components and integrated circuits, such as for example the L6562D described above, or similar integrated circuits, and also receives an operating voltage 120 from an operating voltage power supply 112. A DC-AC inverter stage 108 converts the regulated DC power 107 to an AC lamp power 109 which is used to drive a gas discharge lamp or other load 110 requiring regulated AC power. An inverter power section 136 in the DC-AC inverter stage 108 includes switching devices configured in a bridge circuit to chop the regulated DC power 107 to produce an AC power and includes a resonant tank to shape the chopped DC power as required to drive the lamp or other load 110. Inverter control circuitry 138 receives command signals from a microcontroller unit 114 and generates control signals 126 to drive the inverter power section 136. The control signals 126 also include status signals generated by the inverter control circuitry 138 which provide the microcontroller 114 with information for making determinations and decisions. Similar to control circuitry 130, 134 in the other power stages, 104, 106, the inverter control circuitry 138 receives an operating voltage 120 to operate its components and integrated circuits.

Multi-stage ballast 100 includes an operating voltage power supply 112 used to supply voltages to operate control circuitry within the ballast. Two sources are used to provide input power for the operating voltage power supply 112. During normal ballast operation a coupled power 118 is received from a secondary winding magnetically coupled to an energy storage inductor of the switched mode power converter 128. As will be discussed further below, during certain operating conditions, the coupled power 118 is insufficient, thus an alternate source of power or second power source 116 is provided to the operating voltage power supply 112 by coupling it directly to the rectifier stage 102. The operating voltage power supply 112 is used to provide a common collector voltage (VCC) known as an operating voltage 120 to low level control circuitry, 130, 134, 138 in each of the power stages 104, 106, 108, and also provides a low level voltage (VDD) 124 to operate the microcontroller 114. During periods when the ballast 100 is in a low-power or no-power condition, such as when the lamp 110 is drawing little or no power there is insufficient current flowing through the PFC stage to provide sufficient coupled power 118 to satisfy requirements of the operating voltage power supply 112. Low-load or no-load conditions occur during periods where the load lamp 110 is shut down such as during cool down periods between each ignition cycle or when a lamp has failed or has been removed. During these periods, the alternate source of input power 116 is drawn directly from the rectified input power 103.

The microcontroller 114 is coupled to the DC-AC inverter stage 108. Control signals 126 allow the microcontroller to determine various conditions within the DC-AC inverter stage 108 that may affect the PFC controller 104 and the power regulator stage 106. These conditions include low-load or no-load conditions that prevent the PFC controller 104 from supplying sufficient primary coupled power 118 to the operating voltage power supply 112, and transitions of the DC-AC inverter stage 108 which may induce harmful voltage spikes in the regulated DC power 107 produced by the power regulator stage 106.

The microcontroller unit 114 provides high level control and coordination functions to keep the PFC controller stage 104, power regulator stage 106, and DC-AC inverter stage 108, operating efficiently and to provide functionality such as for example lamp restarting and cool-down. The microcontroller 114 can comprise a small general purpose computer typically constructed on a single integrated circuit or small circuit board containing a processor, memory, and programmable input/output peripherals. In some embodiments the microcontroller unit 114 includes an analog-to-digital converter, digital-to-analog converter, and/or on board counters capable of providing control to the multi-stage ballast 100. The microcontroller unit 114 includes a processor capable of executing computer instructions as well as manipulating and moving data, and a memory capable of storing computer instructions and data.

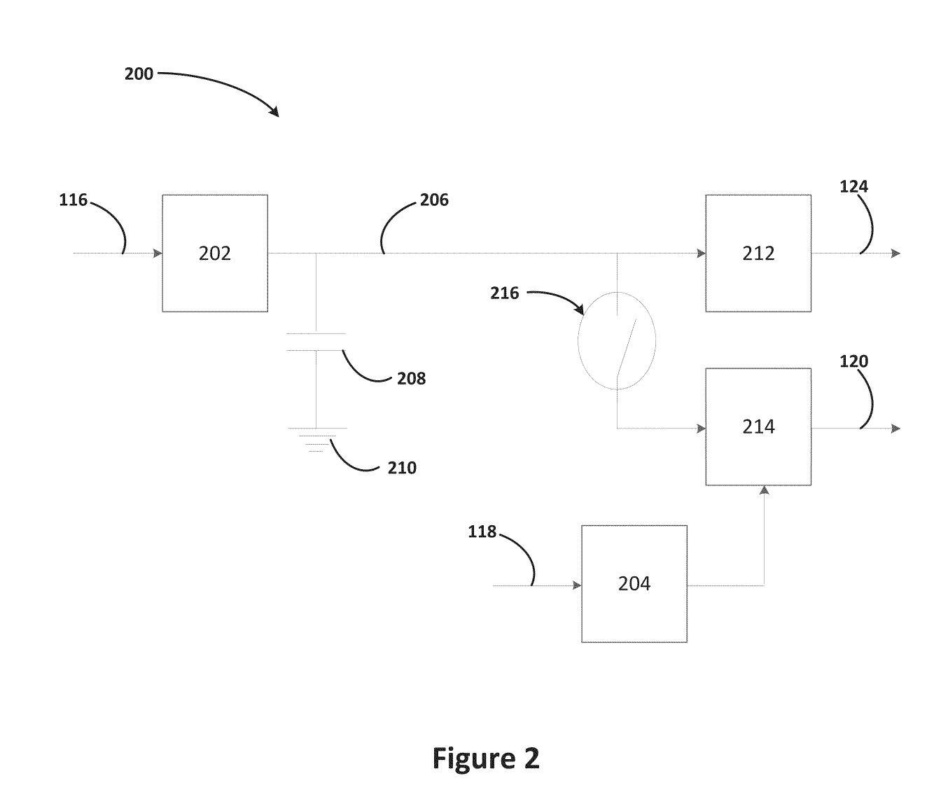

FIG. 2 illustrates a block diagram of an exemplary architecture 200 for an operating voltage power supply 112 appropriate for supplying VDD, an operating voltage, to control circuitry within a multi-stage ballast 100. A linear power supply 202 is coupled directly to an the second power source 116, such as the rectified input power 103, to allow the linear supply 202 to provide power immediately when input power, such as input power 101, is applied to the ballast 100. Linear supply 202 can provide power 206 before the PFC stage 104 is started and when the DC-AC inverter stage 108 is shutdown. Linear supply 202 provides power 206 in the form of an internal voltage that is used by a low level supply 212 to provide VDD 124 that is used by the microcontroller 114. The internal voltage of power 206 is also used by an operating voltage power regulator 214 to provide an operating voltage to control circuitry within the power stages 104, 106, and 108. A coupled power supply 204 receives coupled power 118 from the switched mode power converter 128 and provides an alternate source for the operating voltage power regulator 214.

During operation, the multi-stage ballast 100 needs to support several lamp operating modes. When the load or lamp 110 is lit the ballast 100 is in steady state and the ballast 100 operates under a normal load, i.e. the ballast 100 is providing a normal amount of current to the lamp 110. During ignition, the ballast 100 applies a high ignition voltage to the lamp 110 and is subjected to a light load. During cool-down periods, which are the periods between bursts of ignition voltage applied at startup, during lamp failure, or while a lamp is removed, the ballast 100 is in shutdown mode and is subjected to low-load or no-load in which no lamp current or very little lamp current is flowing.

A linear power supply, such as the linear supply 202, dissipates an amount of power proportional to the amount of current being supplied. A coupled supply such as the coupled supply 204 receives regulated power from a switching regulator such as the boost regulator in the PFC stage 104 and thus dissipates significantly less power. It is therefore desirable to use the coupled supply 204 as much as possible and only draw power from the linear supply 202 when the coupled supply 204 is not able to provide the required operating voltage 206. The coupled supply 204 uses magnetic coupling to draw power from an energy storage inductor in the PFC stage 104, which is typically a boost type switching regulator, and therefore can only supply power while current is flowing through the PFC stage's inductor. The design of the coupled supply 204 can support the power dissipation of VCC 120 and VDD 124 during light and normal loads. However, when the ballast 100 is in a low-load or no-load condition there is insufficient power produced by the coupled supply 204 and the power 206 must be supplied by the linear power supply 202. The operating voltage regulator 214 is configured to draw power from the coupled supply 204 whenever possible and to draw power from the linear supply 202 only when the coupled supply 204 is not providing sufficient power.

Typical ballast designs create the linear supply using power resistors which are reliable but waste significant amounts of power. Alternatively, switching supplies have been used to reduce the amount of wasted power but increase the cost of the ballast and adversely impact reliability. An alternative approach disclosed herein, is to include an operating voltage control switch 216 to control the operating voltage power regulator 214. Operating voltage control switch 216 is coupled to the microcontroller 114 allowing the microcontroller 114 to disconnect the operating voltage power regulator 214 from the linear power supply 202 during periods where it is not necessary to operate control circuitry in the power stages 104, 106, 108. For example, when the ballast 100 enters into a low-load or no-load condition, the switch 216 may be turned off. Since no lamp current is required during these periods, analog circuits and other control circuitry of the PFC controller stage 104, power regulator stage 106, and DC-AC inverter stage 108, does not need to operate so the ballast 100 may be put into a standby mode where the amount of operating voltage power dissipation is significantly reduced. Standby mode is where the ballast 100 is providing little or no current to the lamp 110 such as during cool-down periods, or when a lamp fails or is removed. In typical lamp ballasts, the control circuitry continues to receive power and continues to operate even though it is not providing any power to the load. By removing power from the control circuitry, a multi-stage ballast 100 that includes an operating voltage control switch 216 and a microcontroller 114 programmed to operate the switch 216, can significantly reduce power dissipated during standby mode.

For example, a typical multi-stage ballast 100 uses operating voltage 120 to provide a common collector voltage of about 15 volts at about 8 milliamps. VDD 124 requires a much lower power level of about 5 volts at less than 1 milliamp. Under these conditions a ballast using power resistors in the linear supply 202 will typically dissipate about 3.2 watts. This level of dissipation requires a pair of 2 watt power resistors or equivalent power transistor in the linear supply. Using the new solution where the operating voltage regulator 214 is switched off in standby mode, the power dissipation may be reduced to less than approximately 0.4 watts. In addition to improved energy efficiency, the reduced power dissipation of less than one half watt, allows the power resistors used in a traditional solution to be replaced with less costly surface mount resistors.

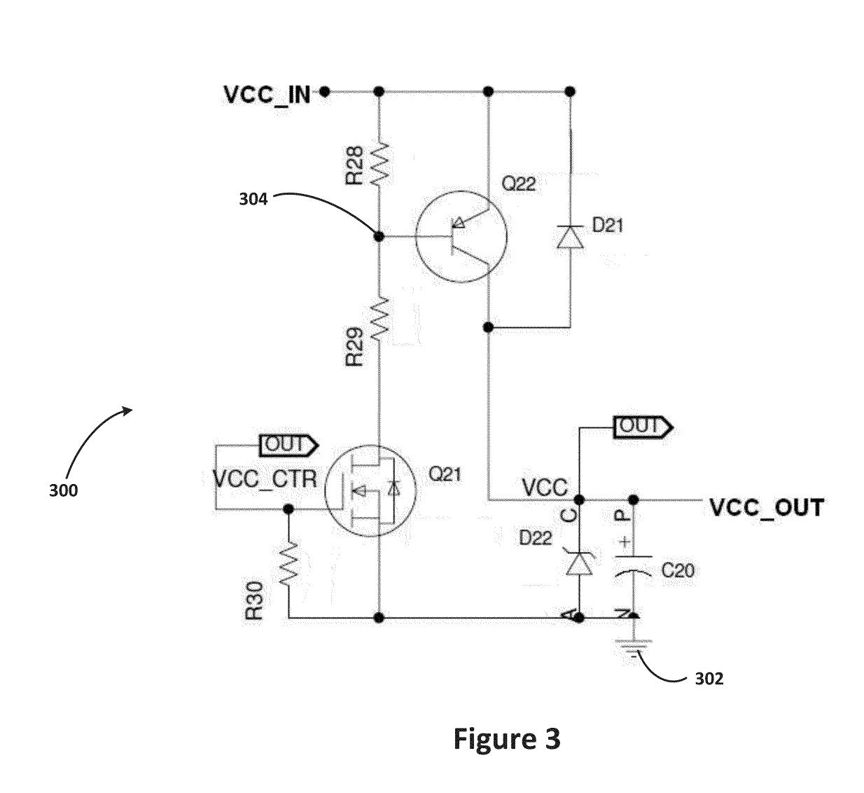

FIG. 3 illustrates a schematic diagram of an exemplary embodiment of a switching circuit appropriate for placing the ballast 100 in standby mode. A circuit of this type may be used as the operating voltage power control switch 216 in the low level supply architecture 200 described above. The switching circuit receives a common collector voltage at a positive supply rail VCC_IN. A switching transistor Q22 selectively connects the supply rail VCC_IN to the output voltage VCC_OUT. A diode D21 not only prevents the output voltage VCC_OUT from exceeding the input voltage VCC_IN, but also provides a current flow to supply the VDD from VCC_OUT. A filter capacitor C20 is connected in parallel with a Zener diode D22 between the output voltage VCC_OUT and circuit ground 302 to stabilize and maintain the output voltage VCC_OUT at a constant voltage, such as for example about 18 volts. A control signal VCC_CTR is applied to the gate of a field effect transistor Q21 and a resistor R30 is used to provide a bias voltage to keep the transistor Q21 turned off when the control signal VCC_CTR is held high. A pair of resistors, R28 and R29, forms a resistor divider network that is connected in series between the supply voltage VCC_IN and the transistor Q21. Transistor Q21 selectively connects the resistor divider R28, R29 to circuit ground 302. A central node 304 between the two resistors R28, R29, is connected to the base of the switching transistor Q22. When the control signal VCC_CTR is pulled to a low level, it turns the transistor Q21 on, which connects the pair of resistors R28, R29 to ground, creating a voltage across resistor R28 to turn the switching transistor Q22 on. When the switching transistor Q22 is on, the output VCC_OUT is connected to the input VCC_IN thereby providing the input voltage to any components connected to the output VCC_OUT.

A microcontroller, such as the microcontroller 114 described above with reference to the multi-stage ballast 100, may be connected to VCC_CTR to operate the switching circuit 300. In a ballast such as the exemplary ballast 100, the microcontroller 114 can determine when the ballast is in a no-load condition. By including a low level supply architecture such as architecture 200 with an operating voltage control switch 216, the microcontroller 114 can be programmed to take advantage of knowledge of the ballast's operating mode and place the ballast in standby mode by opening the operating voltage control switch 216 to reduce the amount of power dissipated by the ballast.

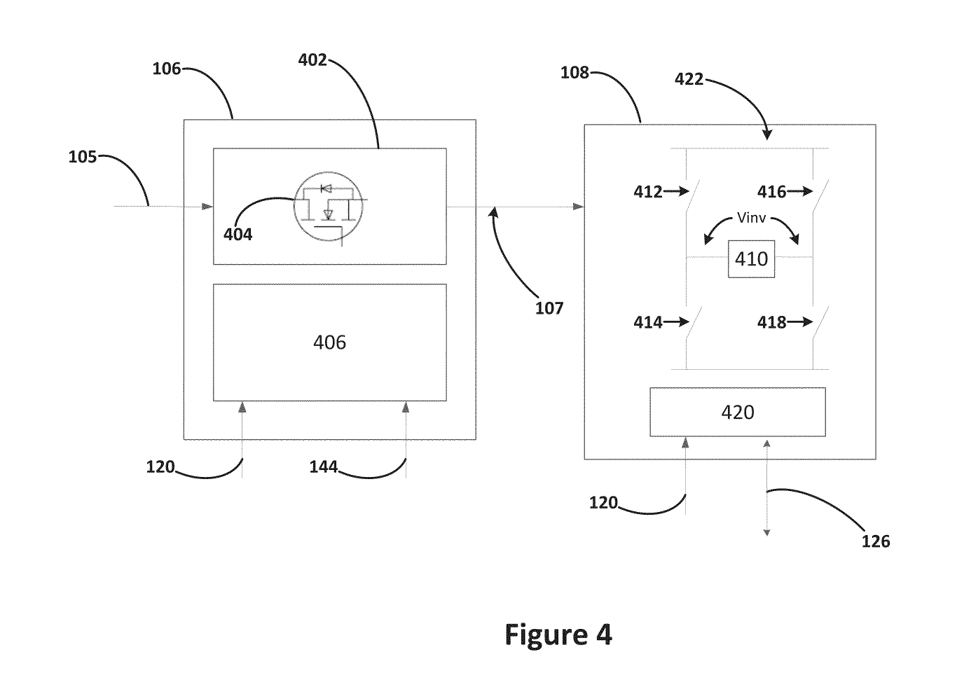

FIG. 4 illustrates an embodiment of a power regulator stage 106 and a DC-AC inverter stage 108 that may be used to reduce the CCF of regulated DC power 107 thereby reducing current spikes delivered to a load 410 through the DC-AC inverter stage 108. Circuitry in the power regulator stage 106, which in one embodiment is a buck regulator, includes power circuits 402 and control circuits 406. The power circuitry 402 is a switching mode type regulator configured using a buck regulator topology as is known in the art and includes a controllably conductive switch 404 known as a buck switch. The buck switch 404 is switched on and off by the control circuit 406 to regulate the DC power 107. Control circuitry 406 is configured to monitor various values within the power regulator stage 106, such as the amount of output power, value of the output voltage, value of the input voltage, and other values as appropriate, and adjusts the duty cycle of the buck switch 404 to maintain the desired DC power 107 characteristics. A duty cycle as used herein refers to the ratio of on-time, which is the period of time during which the buck switch 404 is conducting current, to off-time, which is the period of time during which the buck switch 404 is not conducting current, of the controllably conductive switching device 404. Control circuitry 406 receives a control voltage 120, also known as a common collector voltage (Vcc), from a suitable operating voltage power source as described above. The control circuitry 406 may be of any suitable type, including discrete electronic components and/or integrated circuits, appropriate for controlling the power circuitry 402 and maintaining desired buck regulator output power 107 characteristics.

The DC-AC inverter stage 108 is configured to receive the regulated DC power 107 and provide an AC inverter voltage, Vinv, to the load 410. The load 410 includes a lamp and may also include a resonant tank circuit and/or other current controlling components that help form a required lamp power from the inverter voltage, Vinv. The inverter includes an H-bridge power circuit 422 which is formed from four controllably conductive switching devices 412, 414, 416, 418, such as metal oxide semiconductor field effect transistors (MOSFETs), and receives its operating voltage 120 from a suitable power source and provides a set of external control signals 126 which allow the DC-AC inverter stage 108 to be controlled by an external device such as a microcontroller 114. In operation, the four switching devices 412, 414, 416, 418, are alternately turned on and off in pairs by control circuitry 420 to create a square wave inverter voltage Vinv to drive the load 410. First switching devices 412 and 418 are turned on, while switching devices 414 and 416 are turned off, to apply a forward polarity or positive inverter voltage Vinv to the load 410, then switching devices 414 and 416 are turned on, while switching devices 412 and 418 are turned off, to apply a reverse polarity inverter voltage Vinv to the load 410. When changing the polarity of the inverter voltage Vinv, all four switching devices 412, 414, 416, and 418, generally should be turned off for a brief amount of time to prevent potentially harmful shoot through currents, before turning on the alternate pair of switches. Once the alternate pair of switches is activated it takes a finite amount of time for the switching devices to begin conducting. The period of time during which the inverter voltage is changing polarity is referred to as the inverter transition period or just inverter transition.

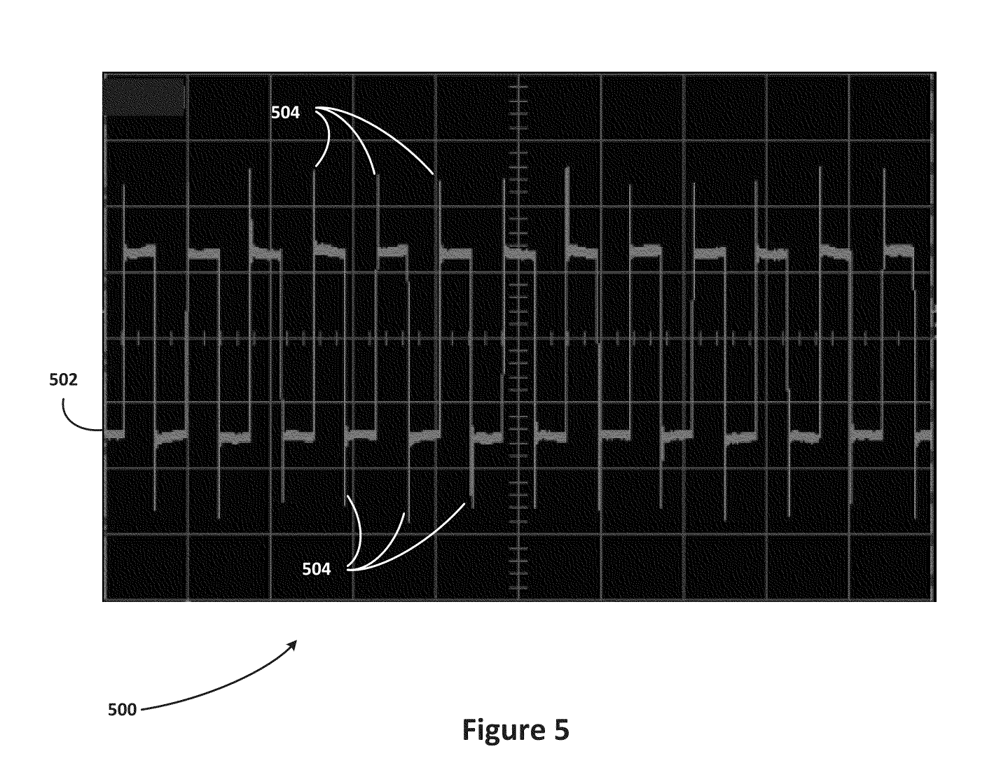

During the inverter transition period the lamp 110 requires only about one third of the power required during normal operation. It is desirable in gas discharge lamps to operate the ballasts in a constant power mode, however due to the reduced lamp power requirements, this control scheme may lead to current spikes during inverter transitions. FIG. 5 illustrates a graph 500 showing current 502 delivered to the load 410 by the H-bridge 422. The magnitude of lamp current is represented on the vertical axis in amperes with each major division representing one ampere. Time is represented on the horizontal axis in seconds with each division representing 10 milliseconds. As can be seen from the graph 500, a large current spike 504 is created each time the inverter transitions between positive and negative voltage. In the illustrated example graph 500 the RMS value of the lamp current 502 is about 1.4 amperes while the peaks 504 are about 2.5 amperes yielding a CCF of about 1.8. These high current spikes cause stress and reduce lamp life.

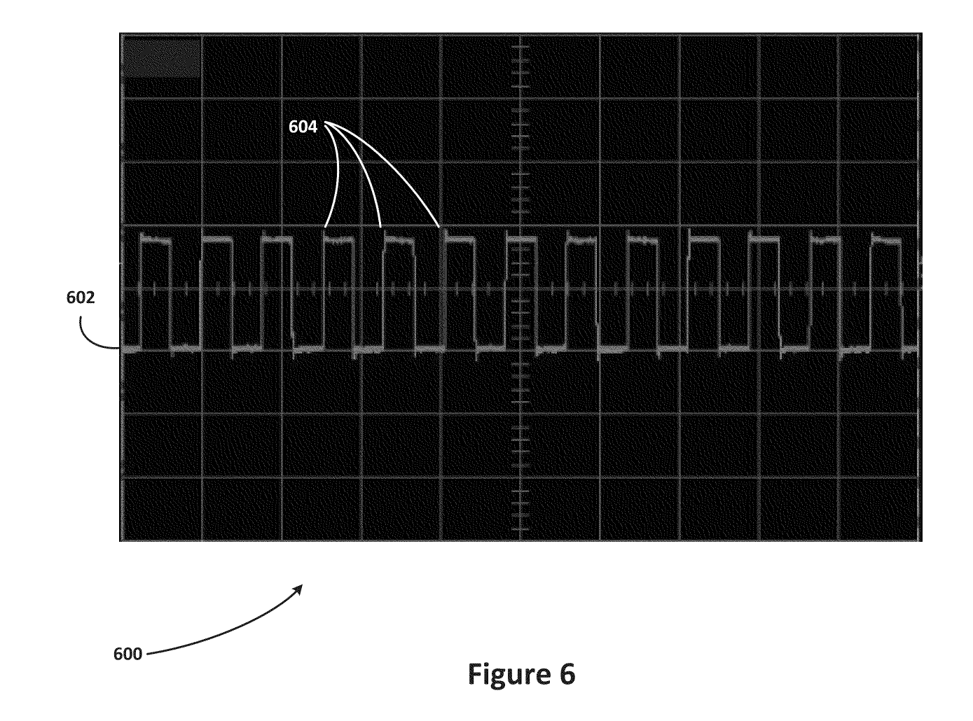

In accordance with the novel embodiments disclosed herein, an additional control input 144 is included and is configured to stop pulse width modulation and turn the buck switch 404 off when the control signal 144 is activated. The exemplary ballast 100 described above includes a microcontroller 114 configured to operate the DC-AC inverter stage 108 through control signals 126. Thus, microcontroller 114 is able to determine when the DC-AC inverter stage 108 is in transition by examining the control signals 126 and activate the buck control signal 144. The microcontroller 114 is programmed to perform a CCF control method where the buck control signal 144, is activated for a predetermined period of time whenever the microcontroller determines that the inverter stage 108 enters transition. By activating the buck control signal 144, the buck switch 404 is turned off during the transition period thereby significantly reducing the current spikes and reducing the CCF of the ballast. FIG. 6 illustrates a graph 600 showing lamp current 602 delivered to a load 410 by a ballast employing the CCF control method just described. The magnitude of lamp current is represented on the vertical axis in amperes with each major division representing one ampere. Time is represented on the horizontal axis in seconds with each division representing 10 milliseconds. The graph 600 shows that the current spikes 604 occurring at each transition are nearly eliminated by the buck control scheme yielding a CCF of close to one.

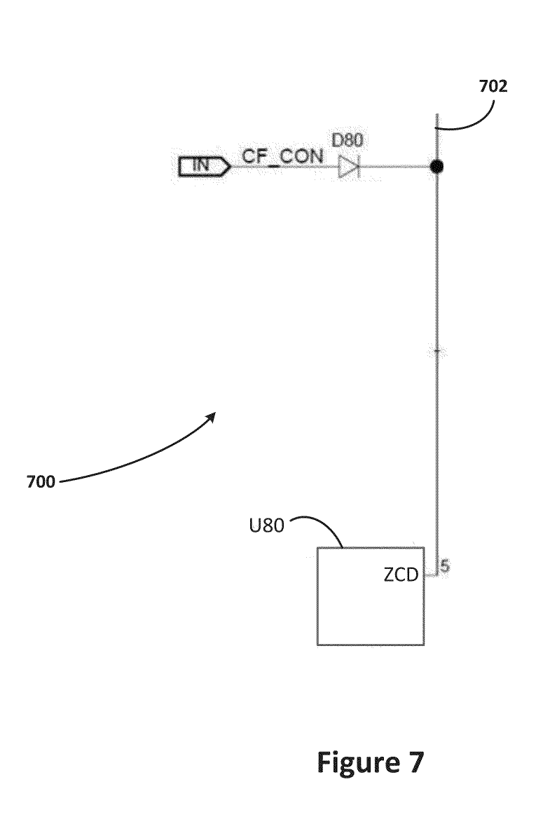

FIG. 7 illustrates an exemplary embodiment of a buck control circuit 700 that may be used to enable and disable switching in certain embodiments of the power regulator stage 106. The buck control circuit 700 may be used to enable a microcontroller 114 to implement the CCF control method described above. It is common to use integrated circuits U80 to control the buck switch 404 in power regulator stages 106. Buck regulators using integrated circuits U80 such as the L6562 manufactured by STMICROELECTRONICS or the UCC 28050 manufactured by TEXAS INSTRUMENTS are known and these buck regulator implementations include a zero current detection (ZCD) input, pin 5, which is used to operate the switching supply in transition mode. Typically, the buck inductor current is indirectly sensed through a bias winding on the boost inductor and is used to generate a zero current detection signal 702 to drive the ZCD input of the integrated circuit U80. The integrated circuit U80 is configured so that a negative going edge on the ZCD input pin 5 causes the buck switch 404 to be turned on. Thus, if the ZCD input is held at a high voltage level, such as for example the operating voltage of the integrated circuit U80 or the operating voltage VDD of the microprocessor 114, a negative going edge will not appear at the ZCD input 5 and the buck switch 404 will not be turned on. A simple crest factor control signal CF_CON input can be created by taking advantage of the functionality of the ZCD input pin 5. Connecting the anode of a diode D80 to the zero current detection signal 702 as shown in FIG. 7 and connecting the CF_CON input or cathode of the diode D80 to a CCF control signal output 126, as illustrated in FIG. 1, of the microcontroller 114, allows the microcontroller 114 to turn off the buck switch 404 for a predetermined period of time during transition periods of the DC-AC inverter stage 108. In this configuration when the microcontroller 114 outputs a logical ‘zero’ or ‘false’ value on the CCF control signal output 126 which is connected to the CCF_CON signal, the diode D80 becomes reverse biased and the zero crossing detection signal 702 is allowed to drive the ZCD pin 5. When the microcontroller 114 outputs a logical ‘one’ or ‘true value on the CCF control signal 126, the diode D80 is forward biased and the ZCD pin 5 will not be provided with a negative going edge and the buck switch 404 will remain off until the microcontroller 114 outputs a logical ‘zero’ on the output pin 126. Alternatively, other circuits may be used to provide the CCF control input 144 on the power regulator stage 106 such that activation of the CCF control input turns the buck switch 404 off.

Thus, while there have been shown, described and pointed out, fundamental novel features of the invention as applied to the exemplary embodiments thereof, it will be understood that various omissions and substitutions and changes in the form and details of devices illustrated, and in their operation, may be made by those skilled in the art without departing from the spirit and scope of the invention. Moreover, it is expressly intended that all combinations of those elements, which perform substantially the same function in substantially the same way to achieve the same results, are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A multi-stage ballast for powering a gas discharge lamp, the ballast comprising:
a power factor correction stage configured to receive an AC input power and produce a phase corrected DC power;
a buck regulator stage coupled to the phase corrected DC power and configured to produce a regulated DC power, the buck regulator stage comprising a buck switch;
a DC to AC inverter stage coupled to the regulated DC power and configured to produce an AC lamp power; and
a microcontroller coupled to the inverter stage and to the buck switch,
wherein the microcontroller is configured to determine when the inverter enters transition and to shut off the buck switch for a predetermined period of time after the inverter enters transition.

2. The multi-stage ballast of claim 1 wherein the power factor correction stage comprises a rectifier coupled to the AC input power and configured to produce a rectified power, and a power factor correction controller coupled to the rectified power and configured to produce the phase corrected power.

3. The multi-stage ballast of claim 2, further comprising an operating power supply configured to produce an operating voltage, and wherein the power factor correction stage, the buck regulator stage, and the inverter stage each comprise control circuitry coupled to the operating voltage, and wherein the microcontroller is further configured to determine when the ballast is in a standby mode and to turn off the operating voltage while the ballast is in standby mode.

4. The multi-stage ballast of claim 3, wherein the operating power supply comprises:
a linear supply coupled to the rectified power and configured to produce an internal voltage;
an operating voltage regulator coupled to the internal voltage and configured to produce the operating voltage; and
an operating voltage control switch coupled between the internal voltage and the operating voltage regulator,
wherein the operating voltage control switch is operably coupled to the microcontroller and the microcontroller is configured to open the operating voltage control switch such that the internal voltage is disconnected from the operating voltage regulator when the ballast is in standby mode.

5. The multi-stage ballast of claim 1 wherein the buck regulator stage further comprises:
an integrated circuit coupled to the buck switch, the integrated circuit comprising a zero crossing detection input;
a current sensing circuit coupled to the regulated DC power and providing a current sensing signal, the current sensing signal being coupled to the zero crossing detection input; and a diode coupled to the zero crossing detection input,
wherein the diode couples a current crest factor control output of the microcontroller to the zero crossing detection signal such that the buck switch is shut off while the output of the microcontroller is held at a high voltage level, and
wherein the microcontroller is configured to hold the current crest factor control output high for a predetermined period of time after the inverter enters transition.

6. An electroluminescent device comprising:
a power factor correction stage coupled to a rectified DC power stage and configured to produce a phase corrected DC power;
a buck regulator stage coupled to the phase corrected DC power and configured to produce a regulated DC power, the buck regulator stage comprising a buck switch;
a DC to AC inverter stage coupled to the regulated DC power stage and configured to produce an AC lamp power;
a microcontroller coupled to the DC to AC inverter stage and to the buck switch;
an internal power supply coupled to the rectified DC power stage and configured to produce a first operating voltage;
a gas discharge lamp coupled to the AC lamp power,
wherein the power factor correction stage, the buck regulator stage, and the DC to AC inverter stage each comprise control circuitry coupled to the first operating voltage, and
wherein the microcontroller is configured to determine when the ballast is in a standby mode and to turn off the first operating voltage while the ballast is in standby mode.

7. The electroluminescent device of claim 6, wherein the operating power supply comprises:
a linear supply coupled to the rectified DC power stage and configured to produce an internal voltage;
an operating voltage regulator coupled to the internal voltage and configured to produce the first operating voltage; and
an operating voltage control switch coupled between the internal voltage and the operating voltage regulator,
wherein the operating voltage control switch is operably coupled to the microcontroller and wherein the microcontroller is configured to open the operating voltage control switch such that the internal voltage is disconnected from the operating voltage regulator when the ballast is in standby mode.

8. The electroluminescent device of claim 7, wherein the operating power supply further comprises a coupled supply configured to receive power from the power factor correction stage and produce a second operating voltage to the operating voltage regulator,
wherein the operating voltage regulator is configured to draw power from the second operating voltage when the second operating voltage comprises sufficient power for the control circuitry and to draw power from the linear supply when the second operating voltage comprises insufficient power for the control circuitry.

9. The electroluminescent device of claim 8, wherein the microcontroller is further configured to determine when the inverter enters transition and to shut off the buck switch for a predetermined period of time after the inverter enters transition.

10. The electroluminescent device of claim 9, wherein the buck regulator stage further comprises:
an integrated circuit coupled to the buck switch, the integrated circuit comprising a zero crossing detection input;
a current sensing circuit coupled to the regulated DC power and providing a current sensing signal, the current sensing signal being coupled to the zero crossing detection input; and a diode coupled to the zero crossing detection input,
wherein the diode couples a current crest factor control output of the microcontroller to the zero crossing detection signal such that the buck switch is shut off while the output of the microcontroller is held at a high logical true value, and
wherein the microcontroller is configured to hold the current crest factor control output at a logical true value for a predetermined period of time after the inverter enters transition.

11. A method for controlling a multi-stage ballast for driving a gas discharge lamp, the multi-stage ballast comprising a boost regulator configured to provide power factor correction, a buck regulator configured to regulate power delivered to the gas discharge lamp, and an inverter configured to produce an AC power for the lamp, the method comprising:
detecting a transition state of the inverter;
turning buck regulator switching off for a predetermined time after detecting the transition state.

12. The method of claim 11, wherein the multi-stage ballast further comprises an operating voltage supply and wherein the boost regulator, the buck regulator, and the inverter each comprise control circuitry configured to receive an operating voltage from the operating voltage supply, the method further comprising:
detecting when the ballast is in a standby mode;
turning the operating voltage supply off while the ballast is in the standby mode.
